(19) United States
(12) Patent Application Publication
(10) Pub. No.: US 2010/0223039 A1
(43) Pub. Date: Sep. 2, 2010

(54) Modeling In Sedimentary Basins

(76) Inventor: Serguei Maliassov, Spring, TX (US)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/681,745

(22) PCT Filed: Nov. 13, 2008
(86) PCT No.: PCT/US08/83434

§ 371 Date: Apr. 5, 2010

Related U.S. Application Data
(60) Provisional application No. 61/008,801, filed on Dec. 21, 2007.

(51) Int. Cl. G06G 7/50; G06F 17/11

(52) U.S. Cl. 703/2; 703/10

(57) ABSTRACT

Embodiments of the invention operate to produce basin models that describe the basin in terms of compaction and fluid flow. The equations used to define compaction and fluid flow may be solved simultaneously. Embodiments of the invention use equations that define a set of unknowns that are consistent over the basis. The equations may define total pressure, hydrostatic pressure, thicknesses, and effective stress.

### CROSS-REFERENCE TO RELATED APPLICATION

This application claims the benefit of U.S. Provisional Patent Application 61/008,801 filed Dec. 21, 2007 entitled MODELING IN SEDIMENTARY BASINS, attorney docket number 2007EM385, the entirety of which is incorporated by reference herein.

### TECHNICAL FIELD

This application relates in general to computer modeling, and more specifically to modeling pressure in sedimentary basins.

### BACKGROUND OF THE INVENTION

In geological exploration, it is desirable to obtain information regarding the various formations and structures that exist beneath the Earth's surface. Such information may include geological strata, density, porosity, composition, etc. This information is then used to model the subsurface basin to predict the location of hydrocarbon reserves and aid in the extraction of hydrocarbon.

Basin analysis is the integrated study of sedimentary basins as geodynamical entities. Sedimentary basins are studied because the basins contain the sedimentary record of processes that occurred on and beneath the Earth's surface over time. In their geometry, the basins contain tectonic evolution and stratigraphic history, as well as indications as to how the lithosphere deforms. Consequently, the basins are the primary repositories of geological information. Furthermore, the sedimentary basins of the past and present are the sources of almost all of the world's commercial hydrocarbon deposits.

Basin simulation models the formation and evolution of sedimentary basins. The simulation addresses a variety of physical and chemical phenomena that control the formation of hydrocarbon deposits in the moving framework of a subsiding basin, e.g. heat transfer, compaction, water flow, hydrocarbon generation, and multiphase migration of fluids. Basin modeling can provide important insights into fluid flow and pore pressure patterns. Note that pressure evaluation is important for both prospect assessment and planning, as pressures can approach lithostatic in some under-compacted areas.

In the typical history of a basis, the deposition of sediment on top of a layer accumulates over time to form another layer. As more layers are added to the top surface, the subsurface layers undergo compaction from the weight of the top-surface layers. The porosity of the subsurface layers is changing as well from compaction. Thus, over time, the porosity is changing. During basin formation, a layer of organic material may be formed on top of a layer of sediment. Over time, the organic layer is covered with other sediment layers. This layer of organic material is referred to as source rock. The source rock is exposed to heat and pressure and the organic material is converted into hydrocarbon deposits. Subsequent pressure causes the hydrocarbon material to be expelled from the source rock and migrate to an entrapment location. Thus, for basin modeling it is important to understand the conditions, e.g. temperature and pressure, at which the hydrocarbon was formed in the source rocks, and the conditions the hydrocarbon is/has been exposed to during its migration. Accurate modeling will allow for a more successful exploration of the basin.

One of the main conditions is pressure, which may be defined by Darcy's Law, which says that liquids will move from a higher pressure area to a lower pressure area and the rate of movement is proportional to the pressure drop. Nonequilibrium compaction and resulting water flow may be represented by Darcy's law for one-phase fluid flow associated with an empirical compaction law and stress-strain behavior in porous media. An example may be found in P. A. Allen and J. R. Allen, “Basin Analysis: Principles and Applications”, Blackwell Scientific Publications, Cambridge, Mass., 1990. Numerical modeling of such a coupled process is complex and has been historically carried out in three areas: geo-mechanical modeling with the primary goal of computing stress-strain behavior, fluid flow modeling in porous media, and fracture mechanics. Note that for modeling involving two or three of these processes, the modeling has always assumed that the processes are uncoupled. In other words, each process is modeled independently of the other processes. Thus, such an approach is unacceptable in situations where there is strong coupling between these processes, for example, in situation of high deposition rate, when rapid changes of porosity and permeability due to stress changes lead to under-compaction, formation of high overpressure with respect to the hydrostatic distribution and, possibly, fracturing of the solid media. An example of such an uncoupled approach can be found in I. L'Heureux and A. D. Flowler, “A simple model of flow patterns in overpressured sedimentary basins with heat transport and fracturing”, Journal of Geophysical Research, Vol. 105, No. B10, pages 23741-23752, 2000.

### SUMMARY

This description is directed to embodiments of systems and methods which accurately model the conditions in a geological basin by evaluating phenomena operating in the basin. Such modeling may including describing compaction processes and fluid flow in sedimentary basins evolving through geologic time.

While modeling compaction processes and fluid flow, a sediment system is considered that comprises a porous solid phase whose interstitial volume is saturated with a liquid which is called the pore fluid. Due to the action of gravity and the density difference between the solid and liquid phases, the solid phase compacts under its own weight (and the weight of other layers) by reducing its porosity, thus leading to the expulsion of the pore fluid out of the solid phase matrix.

Embodiments of the invention use a continuum mechanics approach to express equations for the conservation of mass and momentum. Embodiments of the invention assume a one-dimensional vertical compaction to simplify the compaction phenomena. This allows embodiments of the invention to simultaneously solve equations for both fluid flow and compaction.

Embodiments of the invention, using one-dimensional vertical compaction and three-dimensional pore fluid motion governed by Darcy's law, derive a system of nonlinear equations. One equation is a diffusion equation expressed in terms of the excess pressure with respect to the hydrostatic load. Another equation relates thickness of the solid rock and its porosity. Another equation defines the effective stress using the force balance. A further equation is a constitutive law that relates total vertical stress and pore pressure to porosity. This equation assumes an elasto-plastic behavior of the rock matrix, in other words, that the compaction state of the rock is irreversible, and exhibits hysteresis.

Embodiments of the invention use constitutive laws relating fluid density and pressure, and permeability of the porous rock and its porosity. While embodiments of the invention can use any existing relation, the following dependency of fluid density ρₐ on pressure p is assumed ρₐ=ρₐ⁰·e^{β(p-p}^{ₐₜₘ}⁾, where ρₐ⁰ is the fluid density at atmospheric pressure pₐₜₘ, and the following generic dependency of permeability on porosity K is assumed

$$K ( φ ) = {K}_{0} \frac{{φ}^{n}}{{( 1 - φ )}^{m}} ,$$

where K₀, n, and m are some constants.

Embodiments of the invention operate to produce basin models in a much more efficient manner, in less time, and using less computational resources. Embodiments of the invention allow for compaction and fluid flow to be solved simultaneously rather than using repeated iterations. Embodiments of the invention produce accurate results even when the geologic basin is undergoing rapid change, e.g. high rates of deposition of sediment.

In one general aspect, a method for modeling a physical region, e.g., on a computer, includes receiving data that defines at least one physical characteristic of the physical region; selecting a first phenomena and a second phenomena, wherein the first and second phenomena are coupled over the physical region for modeling; defining a set of equations that describe the first and second phenomena, wherein the equations are consistent over the physical region; simplifying the set of equations by imposing at least one assumption on at least one of the first phenomena, the second phenomena, and the set of equations; and solving the set of equations to simultaneously describe the two phenomena using the data.

Implementations of this aspect may include one or more of the following features. For example, the physical region may be a subsurface geological basin and the two phenomena may be flow of a fluid and compaction of a material in the basin in which the fluid is located. The fluid may be at least one of oil, natural gas, water, a liquid, a gas, and fluid with a radioactive isotope. The material may be sediment. The at least one assumption may include at least one of a rate of sediment accumulation is known; the compaction only occurs in a vertical direction; and/or the compaction is relatively irreversible. The method may include providing a grid on a model of the physical region, wherein the grid comprises a plurality of cells. The solving may be performed for each cell of the grid. During modeling, each cell of the grid may be grown in a vertical direction to model material accumulation over time. During modeling at least one cell may become buried in the model as other cells are grown above the one cell. Each cell may be a parallelepiped cell. An x-direction and a y-direction that define horizontal plane of a cell may be aligned with stratigraphic time lines.

The fluid may be a compressible fluid, and the set of equations may include a first equation that defines an over pressure for each cell, a second equation that defines a cell thickness for each cell, a third equation that defines a material load for each cell, and a fourth equation that defines a hydrostatic pressure for each cell. The fluid may be an incompressible fluid, and the set of equations may include a first equation that defines an over pressure for each cell, a second equation that defines a cell thickness for each cell, and a third equation that defines a material load for each cell. Applying at least one transformation to a cell; wherein the transformation is one of deposition, downlift, uplift, and erosion. At least one boundary condition may be imposed on a cell that is adjacent to an edge of the region. The physical region may be a subsurface geological basin, and the model involves subsurface oil, and the solving assists in the extraction of the oil from the basin. The data may be derived from information from a sensor that measured the at least one physical characteristic of the physical region.

The method may include producing a basin model of the subsurface geological basin based on the set of solved equations. The location of hydrocarbons may be predicted within the physical region based on the basin model. Production infrastructure may be arranged to extract hydrocarbons within the physical region based on the predicted location of the hydrocarbons. Production potential of the physical region for hydrocarbons may be arranged based on the basin model.

In another general aspect, a computer program product having a computer readable medium having computer program logic recorded thereon for modeling a subsurface geological basin on a computer including code that defines a set of equations that describe fluid flow and sediment compaction, wherein the equations are consistent over the basin, and wherein code is simplified by the imposition of at least one assumption on at least one of the fluid flow, sediment compaction, and the set of equations; and code for solving the set of equations to simultaneously to describe the fluid flow and sediment compaction in the basin.

Implementations of this aspect may include one or more of the following features. For example, the computer program logic may include code for providing a grid on a model of the basin, wherein the grid comprises a plurality of cells. The set of equations may include code that describes a first equation that defines an over pressure for each cell; code that describes a second equation that defines a cell thickness for each cell; and code that describes a third equation that defines a material load for each cell.

The computer program product may include code for applying at least one transformation to a cell, wherein the transformation is one of deposition, downlift, uplift, and erosion. The at least one assumption may include a first assumption that a rate of sediment accumulation is known; a second assumption that the compaction only occurs in a vertical direction; and a third assumption that the compaction is relatively irreversible. The fluid may be oil.

In another general aspect, a method for modeling a sub-surface geological basin on a computer includes receiving data that defines at least one physical characteristic of the basin; defining a set of equations that describe a fluid flow and a compaction of sediment in the basin, wherein the equations are consistent over the physical region; simplifying the set of equations by imposing an assumption that the compaction only occurs in a vertical direction; and solving the set of equations to simultaneously describe the two phenomena using the data.

Implementations of this aspect may include one or more of the following features. The model may involve subsurface oil. The method may further include deriving the data from information from a sensor that measured the at least one physical characteristic of the physical region. The solved equations may be used to assist in the extraction of the oil from the basin. The physical region may be a subsurface geological basin and the two phenomena may be flow of a fluid and compaction of a material in the basin in which the fluid is located. A basin model of the subsurface geological basin may be produced based on the set of solved equations. The location of hydrocarbons within the physical region may be predicted based on the basin model. Production infrastructure, e.g., pumps, compressors, and/or a variety of surface and subsurface equipment and facilities, may be arranged to extract hydrocarbons within the physical region based on the predicted location of the hydrocarbons. Production potential of the physical region for hydrocarbons may be evaluated based on the basin model.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 depicts an example of a model showing compaction of a cell in a domain over time, according to embodiments of the invention;

FIG. 2 depicts an example of the formation of a model cell by sedimentation, according to embodiments of the invention;

FIG. 3 an example of a cell located within a layer of a multilayer domain, according to embodiments of the invention;

FIG. 4 depicts an example of flux moving from one cell of a domain to another cell of the domain, according to embodiments of the invention;

FIG. 5 depicts an exemplary method for modeling a physical region, according to embodiments of the invention; and

FIG. 6 depicts a block diagram of a computer system which is adapted to use the present invention.

### DETAILED DESCRIPTION OF THE INVENTION

Embodiments of the invention are useful for modeling subsurface oil fields. The examples of the embodiments described herein may reference such oil fields. However, the embodiments may be used to model other domains involving other materials and/or processes. For example, embodiments can be used to model distribution of contaminant liquids in the subsurface basin, migration of radioactive substances from the underground storage facilities, or migration of other liquids, water, natural gas, or other gases.

The data used in such simulations can be derived by various techniques such as stratigraphic analysis, seismic inversion, or geological interpretation of those by geoscientists, using sensors to measure various characteristics of the basin.

The following describes compaction, decompaction, and fluid flow modeling according to embodiments of the invention. The models preferably take into account a version of mechanical equilibrium of the media. In the description, a set of assumptions is considered, which leads to the formulation of general fluid flow model in the compacting domain. Also, the description defines simplifying assumptions that may be applied to the model, which reduces the needed computations.

### Balance of Mass, Momentum, and Constitutive Relations

Material balance for sediments and fluids, force balance, and rheological constitutive relations may be considered to provide an appropriate basin model according to embodiments of the invention. The model may use general assumptions and use specific considerations to simplify the modeling process.

A geologic basin may be represented as a set of layers of different thicknesses stacked together. In come locations in the basin, the thickness of a layer degenerates to zero, forming a pinch-out. For simplicity of description later, a basin shall be considered topologically as a parallelepiped region or a plurality of parallelepiped regions, known as cells. Note that a prismatic grid formed according to an embodiment defined in U.S. Patent Application 61/007,761 [Attorney Docket No. 2007EM361], entitled “MODELING SUBSURFACE PROCESSES ON UNSTRUCTURED GRID,” filed Dec. 14, 2007, can be used instead.

The following equation may represent a single parallelepiped region:

{(x,y,z;t):0≦x≦X,0≦y≦Y,Zₜₒₚ(x,y;t)≦z≦Z_{bot}(x,y;t)},

where X and Y form a horizontal plane, and Zₜₒₚ(x,y;t) is the upper layer of the sediment, while Z_{bot}(x,y;t) is the lower layer of sediment or the basement rock.

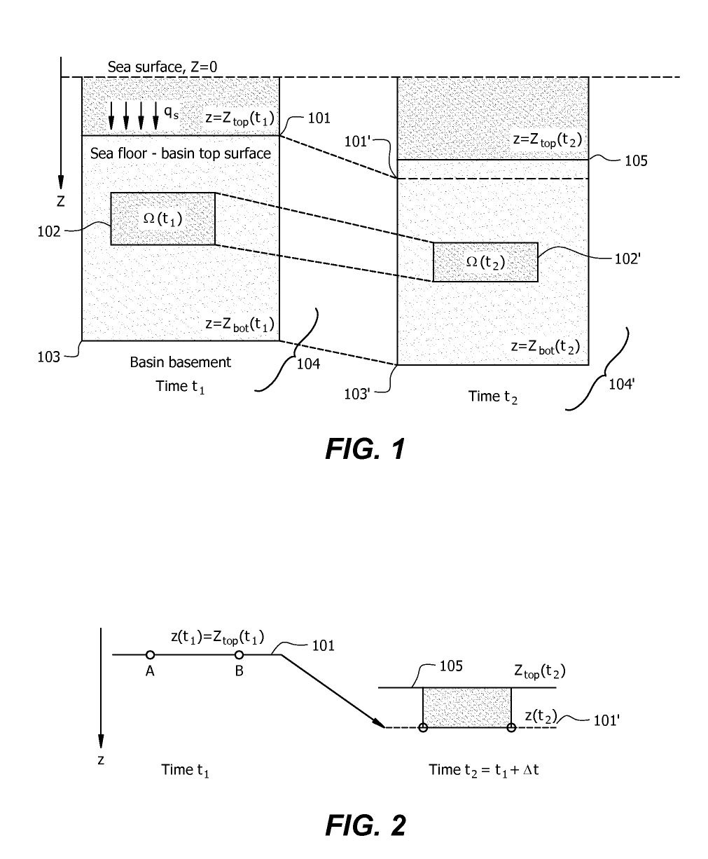

FIG. 1 depicts an example of a compaction processes on a computational domain or region 104. At time t₁, the region 104 has top surface 101 and basement layer 103. The area of interest is shown as subregion 102. This region may comprise source rock. Note that the Zₜₒₚ, as shown in FIG. 1, may be on the surface of the earth, a surface below the earth's surface, or the seafloor. The region 104 is accumulating additional sediment at a rate of deposition of qₛ, and at time t₂, the original top layer 101 is now a subsurface layer 101′, and the region has a new top layer 105. The weight of the additional sediment has cause the area of interest 102 to become deeper and compacted, as shown by area 102′. The bottom layer 103′ has also moved deeper from the surface. A liquid contained within region 102′ will experience an increase in pressure, which acts to cause the liquid to be expelled from region 102′.

Note that it is assumed that the change in top surface 101 is known, i.e. the function Zₜₒₚ(x,y;t) is prescribed. The depth of the basement rock Z_{bot}(x,y;t) may be calculated at each point (x,y) and at each time t. The computational domain bounded by the curves Zₜₒₚ(x,y;t) and Z_{bot}(x,y;t) can grow or shrink in time due to deposition of sediments or erosion. The rate of deposition qₛ may be unknown, but for the purpose of describing embodiments of the present invention it is a known function of time and space.

Even though the embodiments are not bounded by the dimensionality of the domain, the following paragraphs assume that compaction is exhibited in one-dimension (e.g. vertical) and may be nonlinear. In the following, z(t) will denote the coordinate of material point with respect to the sea level z=0 at time t. Note that the same material point will have different coordinate z(t′) at time t′. The negative value of the coordinate z<0 denotes elevation above the sea level.

The model for compaction may be viewed as the process of soil consolidation. The sediments act as a compressible porous matrix. An element of porous rock occupying volume Ω(t₁) at time t₁ due to compaction of pore size will occupy volume Ω(t₂) at time t₂ and have the same rock matrix density and the same mass, see area 102 and 102′ of FIG. 1. The rock mass conservation equation will have the form

$$\frac{\partial ( 1 - φ ) {ρ}_{s}}{\partial t} + ∇ \cdot ( ( 1 - φ ) {ρ}_{s} {v}_{r} ) = 0 , \qquad ( 1.1 )$$

where ρₛ is the solid rock mass density, φ is the porosity, and vᵣ is the rock particle velocity. It is assumed that the rock is inert and has the constant rock matrix density for each type of sediment. The zero in the right hand side of equation (1.1) means that any volume sources of solid material are not considered. The deposition of the sediments can be taken into account as a boundary condition. Note that erosion should be described separately after the dependency of porosity on pressure and effective stress is considered.

When considering one-dimensional vertical compaction, the rock particle velocity is a vector with one nonzero component, such that Vᵣ=(0,0,uₛ)^{T} and equation (1.1) becomes

$$\frac{\partial }{\partial t} ( {ρ}_{s} φ ) - \frac{\partial }{\partial z} ( ( 1 - φ ) {ρ}_{s} {u}_{s} ) = 0. \qquad ( 1.2 )$$

The boundary condition for equation (1.2) is set through the sedimentation rate of rock matrix. At each time the porous rock is deposited with known rate of deposition qₛ(t)≧0 and known porosity φ₀(t). In a small period of time Δt, the following amount of rock is added to the domain

ΔM_{rock}=a·Δt·qₛ(t), (1.3)

where a is small surface area around some point (x,y,Zₜₒₚ(x,y;t)).

FIG. 2 depicts that action of the sedimentation on the surface layer 101 of FIG. 1. FIG. 2 shows the top layer of the basin at time t₁ and time t₂, where t₂=t₁+Δt, when portion of sediment is deposited on the top surface of the domain. Note that points A and B are initially on the top surface with z-coordinate z(t₁)=Zₜₒₚ(t₁), and are buried after deposition and have new z-coordinates z(t₂)>Zₜₒₚ(t₂).

Since the density of rock matrix is known, the deposited amount of rock should be equal to

ΔM_{rock}=a·((z(t₂)−z(t₁))−(Zₜₒₚ(t₂)−Zₜₒₚ(t₁))·(1−φ₀(t))·ρₛ(z(t₁)). (1.4)

Comparing equations (1.3) and (1.4) for an infinitesimally small period of time Δt, and taking a limit as Δt tends to 0, the following expression for the velocity of the material point at the top boundary of the domain can be obtained

$${u}_{s} {\vert}_{{Z}_{top} ( t )} = \frac{\partial {Z}_{top} ( t )}{\partial t} + \frac{{q}_{s} ( t )}{ρ ( {Z}_{top } ( t ) ) \cdot ( 1 - {φ}_{0} ( t ) )} . \qquad ( 1.5 )$$

Since function Zₜₒₚ(t) is known, its derivative is also known, and, thus the right hand side is fully determined as far as the rate of deposition qₛ is provided.

In case of erosion, i.e. removal of the rock from the top surface, qₛ<0, the rock should have the porosity acquired during compaction. In that case equation (1.5) is changed as follows

$${u}_{s} {\vert}_{{Z}_{top} ( t )} = \frac{\partial {Z}_{top} ( t )}{\partial t} + \frac{{q}_{s} ( t )}{ρ ( {Z}_{top } ( t ) ) \cdot ( 1 - φ ( {Z}_{top} ( t ) ) )} . \qquad ( 1.6 )$$

The case of internal erosion, e.g. removal of the rock substance from underground layers shall be handled in a similar way. The rate of removal for the purpose of current description is assumed to be known.

Thus, the boundary condition becomes nonlinear with respect to the porosity function.

For a small area ds around a point (x,y) in xy-plane consider the column of the rock

C(x,y;t)={ds×(Zₜₒₚ(x,y;t),Z_{bot}(x,y;t))}.

At any fixed time t the total mass of the rock in that column will be given by the integral

$${M}_{s} ( x , y ; t ) = {\int }_{C ( x , y ; t )} ( 1 - φ ( x , y , z ; t ) ) {ρ}_{s} ( x , y , z ; t ) d x d y d z .$$

Subdividing both parts of this expression by area ds and taking a limit as ds tends to 0 provides

$$M ( t ) = {\int }_{{Z}_{top} ( t )}^{{Z}_{bot} ( t )} ( 1 - φ ( ξ ; t ) ) {ρ}_{s} ( ξ ; t ) d ξ . \qquad ( 1.7 )$$

That expression holds for any point (x,y) so dependency on (x,y) may be ignored for simplicity.

Taking the material derivative of M(t) with respect to time and using equations (1.5) and (1.6) the following equation may be derived

$$\frac{D}{Dt} M ( t ) = {q}_{s} ( t ) . \qquad ( 1.8 )$$

Now integrating equation (1.8) over time interval and substituting into equation (1.7) the integral form of sediment mass balance can be obtained

$${\int }_{{Z}_{top} ( t )}^{{Z}_{bot} ( t )} ( 1 - φ ( ξ ; t ) ) {ρ}_{s} ( ξ ; t ) d ξ = {\int }_{0}^{t} {q}_{s} ( τ ) d τ . \qquad ( 1.9 )$$

This approach allows determination of the position of a material point, which was deposited at some time t₀>0, at later time t>t₀. Consider the material point at the top surface of the domain at time t₀, i.e., having vertical position z(t₀)≡Zₜₒₚ(t₀). If the sedimentation rate is nonzero, then the point will be buried and at time t>t₀ it will have the position z(t)>Zₜₒₚ(t). Considering mass balance for the column from Zₜₒₚ(t) to z(t) it is possible to obtain the following equality

$${\int }_{{Z}_{top} ( t )}^{z ( t )} ( 1 - φ ( ξ ; t ) ) {ρ}_{s} ( ξ ; t ) d ξ = {\int }_{{t}_{0}}^{t} {q}_{s} ( τ ) d τ . \qquad ( 1.10 )$$

Using equation (1.10) a more general form of mass balance may be derived. Consider the material point at position z(t₀)≧Zₜₒₚ(t₀) at some time t₀≧0. These equations couple compaction and fluid flow. Then at later time t₁≧t₀ that point will have the position z(t₁), which is given by

$${\int }_{{Z}_{top} ( {t}_{1} )}^{z ( {t}_{1} )} ( 1 - φ ( ξ ; {t}_{1} ) ) {ρ}_{s} ( ξ ; {t}_{1} ) d ξ = {\int }_{{Z}_{top} ( {t}_{0} )}^{z ( {t}_{0} )} ( 1 - φ ( ξ ; {t}_{0} ) ) {ρ}_{s} ( ξ ; {t}_{0} ) d ξ + {\int }_{{t}_{0}}^{{t}_{1}} {q}_{s} ( τ ) d τ . \qquad ( 1.11 )$$

For simplicity, a single-phase fluid flow case is considered. The material balance equation for a fluid, which is used for determination of sedimentation/erosion history of the basin and forward compaction processes, has the following form

$$\frac{\partial {ρ}_{a} φ}{\partial t} + ∇ \cdot ( {ρ}_{a} φ {v}_{r} ) - ∇ \cdot {ρ}_{a} \frac{K}{{μ}_{a}} ( ∇ p - {ρ}_{a} g ∇ z ) = 0 , \qquad ( 1.12 )$$

where ρₐ is the fluid density, μₐ is the fluid viscosity, and K is permeability. It is assumed that these variables are known functions.

After introduction of the pressure potential

Φ=p−ρₐgz

equation (1.12) can be rewritten as

$$\frac{\partial {ρ}_{a} φ}{\partial t} + ∇ \cdot ( {ρ}_{a} φ {v}_{r} ) - ∇ \cdot {ρ}_{a} \frac{K}{{μ}_{a}} ∇ Φ = 0. \qquad ( 1.13 )$$

At the bottom boundary or basin basement 103, a no flow condition may be assumed. On a vertical boundary, such as basin top surface 101, it is possible to have either a no flow condition or a flow condition boundary. For the sake of simplicity, it will be assumed that the vertical boundaries have a no flow condition; however, embodiments of the invention may have a flow condition.

Another assumption for the following example is that the domain of interest is below sea (or water table) level. This in turn leads to the assumption that the rock below sea level is full of water. In other words, the pore volume of the deposited sediment contains water. The rate of deposition is denoted by qₐ(x,y;t). For small area ds around a point (x,y,Zₜₒₚ(x,y;t)) during a small period of time Δt, the following amount of water will be added to the basin (Note that (x,y) is omitted for simplicity)

$$\begin{matrix}Δ {M}_{a} = ds \cdot Δ t \cdot {q}_{a} ( t ) \\ = ds \cdot Δ t \cdot ( {u}_{s} {\vert}_{{Z}_{top} ( t )} - \frac{\partial {Z}_{top}}{\partial t} ) \cdot {φ}_{0} ( t ) \cdot {ρ}_{a} ( {Z}_{top} ( t ) ) .\end{matrix}$$

Applying equation (1.5) yields

$${q}_{a} ( t ) = \frac{{ρ}_{a} ( {Z}_{top} ( t ) ) {φ}_{0} ( t )}{{ρ}_{a} ( {Z}_{top} ( t ) ) ( 1 - {φ}_{0} ( t ) )} {q}_{s} ( t ) . \qquad ( 1.14 )$$

In case of erosion, equation (1.14) is changed as follows

$${q}_{a} ( t ) = \frac{{ρ}_{a} ( {Z}_{top} ( t ) ) φ ( {Z}_{top} ( t ) ; t )}{{ρ}_{a} ( {Z}_{top} ( t ) ) ( 1 - φ ( {Z}_{top} ( t ) ; t ) )} {q}_{s} ( t ) . \qquad ( 1.15 )$$

The derivation of integral form of fluid mass balance on a parallelepiped cell (for example cell 102) connected with moving sediment begins as follows

C(t)={(x,y,z):x₀≦x≦x₁,y₀≦y≦y₁,z₀(t)≦z≦z₁(t)}.

At any fixed time t the total mass of fluid in that cell is given by the integral

$${M}_{a} ( C ( t ) ) = {\int }_{C ( t )} {ρ}_{a} φ d Ω .$$

For any cell, which frame moves with the material points

$$\frac{\partial {z}_{0}}{\partial t} = {u}_{s} {\vert}_{{z}_{0}} and \frac{\partial {z}_{1}}{\partial t} = {u}_{s} {\vert}_{{z}_{1}} . \qquad ( 1.16 )$$

Combining equations (1.13) and (1.16) yields

$$\frac{D}{Dt} {M}_{a} ( C ( t ) ) - {\int }_{C ( t )} ∇ \cdot ( {ρ}_{a} \frac{K}{{μ}_{a}} ∇ Φ ) d Ω = {\int }_{C ( t )} {q}_{a} d Ω . \qquad ( 1.17 )$$

For any cell adjacent to the top boundary 101, for example, if the upper surface of cell 102 included a portion of surface 101, then the following equation is used

Cₜₒₚ(t)={(x,y,z):x₀≦x≦x₁,y₀≦y≦y₁,Zₜₒₚ≦(t)≦z≦z₁(t)},

using equations (1.5) and (1.6) instead of equation (1.16) provides the time derivatives as follows

$$\frac{\partial {Z}_{top}}{\partial t} = {u}_{s} {\vert}_{{Z}_{top}} - \frac{{q}_{s} ( t )}{{ρ}_{s} ( 1 - \overline{φ} )} {\vert}_{{Z}_{top}} and \frac{\partial {z}_{1}}{\partial t} = {u}_{s} {\vert}_{{z}_{1}} , \qquad ( 1.18 )$$

where φ̅=φ₀ for deposition or φ̅=φ for erosion. For such a cell, equation (1.17) should be modified as follows

$$\frac{D}{Dt} {M}_{a} ( C ( t ) ) - {\int }_{C ( t )} ∇ \cdot ( {ρ}_{a} \frac{K}{{μ}_{a}} ∇ Φ ) d Ω = {\int }_{C ( t )} {q}_{a} d Ω + {\int }_{{y}_{0}}^{{y}_{1}} {\int }_{{x}_{0}}^{{x}_{1}} \frac{{ρ}_{a} \overline{φ} {q}_{s} ( t )}{{ρ}_{s} ( 1 - \overline{φ} )} {\vert}_{{Z}_{top}} d s , \qquad ( 1.19 )$$

where the last integral represents mass of fluid added or removed from the system due to the processes of deposition or erosion, respectively.

For a fluid flow in porous medium, the total momentum equation can be written as

∇·\hat{σ}+ρg=0, (1.20)

where \hat{σ} is the stress tensor. The bulk density ρ is a sum of the densities of constituents weighted by volume fractions as follows

ρ=ρₛ(1=φ)+ρₐφ. (1.21)

The stress tensor can be considered in the form \hat{σ}=diag(0,0,−σ), where the minus sign is introduced in keeping with rock mechanics usage. Then equation (1.20) can be expressed in another form

$$\frac{\partial σ}{\partial z} = ( {ρ}_{s} ( 1 - φ ) + {ρ}_{a} φ ) g . \qquad ( 1.22 )$$

The effective stress σ_{E} and lithostatic load L can be expressed as differences between stress σ and fluid pore pressure p and hydrostatic pressure pₕ, respectively

σ_{E}=σ−p and L=σ−pₕ. (1.23)

Using the definition of pressure potential effective stress has another form

σ_{E}=L−Φ.

Consequently, the force balance equation (1.22) can be expressed in terms of σ_{E} and L as follows

$$\frac{\partial {σ}_{E}}{\partial z} = \frac{\partial ( L - Φ )}{\partial z} . \qquad ( 1.24 )$$

For a compressible fluid, the hydrostatic pressure at any point is given by

$${p}_{h} ( z ; t ) = p ( {Z}_{top} ( t ) ) + g {\int }_{{Z}_{top} ( t )}^{z} {ρ}_{a} ( p ( ξ ) ) d ξ . \qquad ( 1.25 )$$

Combining equations (1.22) and (1.25) the lithostatic load can be written as

$$L ( z ; t ) = g {\int }_{{Z}_{top} ( t )}^{z} ( {ρ}_{s} - {ρ}_{a} ( p ( ξ ) ) ) ( 1 - φ ) d ξ . \qquad ( 1.26 )$$

Based on the experimental observations in sedimentary basins by Athy in L. Athy, “Density, porosity, and compaction of sedimentary rocks”, Bul. Am. Assoc. Geol., 14 (1930), pp. 1-24, it was proposed that a direct relationship exists between the porosity (1) and the depth z. In its simplest form, this relation can be presented by

φ=φ₀e^{-bz}. (1.27)

The observations are such that the porosity is a function of effective stress σ_{E}, φ=φ(σ_{E}), and it is through the dependence of the effective stress σ_{E} on depth for normally pressured sediments that relations such as those set forth in equation (1.27) can be inferred. For example, see P. Allen and J. Allen, “Basin Analysis, Principles and Applications”, Blackwell Scientific Publications, Cambridge, Mass., 1990, which is hereby incorporated herein by reference in its entirety. Thus, while the porosity-depth relation for normally pressured rocks seems robust, the inference of a relation between Φ and z is merely a convenience. In other words, porosity and load are connected at each point. In embodiments of the invention, the porosity is considered as a function of effective stress. Note that other embodiments of the invention may use other types of rheology. Moreover, the constitutive porosity-effective stress relation may be assumed in the form of double exponent as follows

φ=φ_{c}+φ₁e^{-b}^{₁}^{σ}^{_{E}}+φ₂e^{-b}^{₂}^{σ}^{_{E}}, (1.28)

where φ_{c} is a cut-off (irreducible) porosity, and (φ_{c}+φ₁+φ₂) is the porosity of the sediment at surface conditions.

Generally, sediments are buried with time and not exhumed with time, thus stress tends to increase over the time in the model. In models accounting for erosion, however, the effective stress σ_{E} is likely to decrease. In this case, the porosity is allowed to have slight increase according to the formula

φ=φ_{c}+(φ₀−φ_{c})e^{-bσ}^{_{E}}^{-b}^{ᵤₗ}^{(σ}^{_{E}}^{^{new}}^{-σ}^{_{E}}) (1.29)

where σ_{E}^{new} is a new, decreased, effective stress at the same material point and βᵤₗ is an unloading compressibility.

To consider the irreversible nature of compaction and allow for a small decompaction as effective stress decreases due to erosion, a porosity is assumed to be a time dependent function of two variables, namely the effective stress at any given time t and the historical maximum of the stress achieved over all previous life time of the model, and can be expressed as follows

φ(z(t))=φ(σ_{E}(z(t)),σ_{E}^{max}(z(t))),

where

$${σ}_{E}^{max} ( z ( t ) ) = {sup}_{τ \leq t} \{ {σ}_{E}^{max} ( z ( τ ) ) \} ,$$

and z(t) is a z-coordinate of a material point at time t and the function σ_{E}(z) is defined by equation (1.23).

If at any given time effective stress becomes less than its historical maximum, then equation (1.29) is applied to compute the porosity. Otherwise equation (1.28) is used.

### Fully Coupled Pressure Model

Based on balance of masses, momentums, and constitutive relations described in the above section, the single-phase fluid flow in compacting domain is described by the following set of equations. Note that there are four unknowns to solve for at each particular cell, which are porosity φ(z(t)), pressure potential Φ(z;t), lithostatic load L(z;t), and hydrostatic pressure pₕ(z;t).

Set 2.1:

$$\frac{\partial {ρ}_{a} φ}{\partial t} + ∇ \cdot ( {ρ}_{a} φ {u}_{s} ) - ∇ \cdot {ρ}_{a} \frac{K}{{μ}_{a}} ∇ Φ = {q}_{a} , \\ \frac{\partial }{\partial t} ( {ρ}_{s} φ ) - \frac{\partial }{\partial z} ( ( 1 - φ ) {ρ}_{s} {u}_{s} ) = 0 , \\ \frac{\partial L}{\partial z} = ( {ρ}_{s} - {ρ}_{a} ) ( 1 - φ ) g , \\ {σ}_{E} = L - Φ , \\ {σ}_{E}^{max} ( z ( t ) ) = {sup}_{τ \leq t} \{ {σ}_{E}^{max} ( z ( τ ) ) \} , \\ φ ( z ( t ) ) = φ ( {σ}_{E} ( z ( t ) ) , {σ}_{E}^{max} ( z ( t ) ) ) , \\ {p}_{h} ( z ; t ) = p ( {Z}_{top} ( t ) ) + g {\int }_{{Z}_{top} ( t )}^{z} {ρ}_{a} ( {p}_{h} + Φ ) d ξ , \\ {u}_{s} {\vert}_{{Z}_{top} ( t )} = \frac{\partial {Z}_{top} ( t )}{\partial t} + \frac{{q}_{s} ( t )}{{ρ}_{s} \cdot ( 1 - φ )} {\vert}_{{Z}_{top}} , \\ p ( {Z}_{top} ( t ) ) = {p}_{atm} + {ρ}_{sea} g \cdot max \{ 0 , {Z}_{top} \} , \\ ( x , y , z ( t ) ) ∈ \{ \begin{matrix}( x , y , z ; t ) : 0 \leq x \leq X , 0 \leq y \leq Y , \\ {Z}_{top} ( x , y ; t ) \leq z \leq {Z}_{bot} ( x , y ; t )\end{matrix} \} ,$$

where Zₜₒₚ(x,y;t) is the basin top surface 101 (or sea floor) and Z_{bot}(x,y;t) is the basin basement 103 of FIG. 1. Thus, the system of equations, Set 2.1, is fully determined, as long as the deposition rate qₛ(x,y;t) is prescribed.

The system of equations defined as Set 2.1 above, is considered within curvilinear coordinate system that follows basin stratigraphy. In other words, the x and y directions lie along stratigraphic time lines and hence curve to follow the dip of basin area. This stipulation maintains the axis of the coordinate system along the direction of the greatest permeability (the principal axis of the permeability ellipsoid), which in an unfractured basin strata is commonly aligned along stratigraphy.

The z direction is treated as if it where normal to x, but the z direction actually lies along the vertical. The orientation is positive downward with its origin at the basin top surface or sea level. The fact that the coordinate system is not truly orthogonal except when considering flat-lying sediments, introduces an error into the calculations. At the dips of a typical of basin strata, this error is rather small, especially when compared to the error that would be introduced if the coordinate system were orthogonal but skewed with respect to the axes of the permeability ellipsoid.

Embodiments of the invention assume that the permeable medium has a layered structure and each layer has uniform properties. In other words, the coefficients φ_{c}, φ₁, φ₂, b₁, and b₂ from equation (1.28), and the rock density ρₛ from equation (1.21) are assumed to be piecewise constant. Thus, if each column corresponding to the surface point (x,y) is considered to be partitioned into n_{z} layers, such that

z₀≡Zₜₒₚ≦z₁≦ . . . ≦zₙ_{_{z}}₋₁≦zₙ_{_{z}}≡Z_{bot},

then at any moment of time, in each layer the coefficients φ_{c}^{(l)}, φ₁^{(l)}, φ₂^{(l)}, b₁^{(l)}, b₂^{(l)}, and ρₛ^{(l)} are constants, l=1, . . . , n_{z}.

In other embodiments of the invention, it is assumed that the development of the basin is modeled from some time Tₛ<0 in the past until present time Tₑ=0. The layers from the top to bottom are enumerated. The start and stop deposition times for each layer is denoted as tₛ₁ and tₑ₁, respectively. This leads to the assumption that every l-th layer is deposited before the (l−1)-th layer such that

Tₛ=tₛₙ_{_{z}}<tₑₙ_{_{z}}≦tₛₙ_{_{z}}₋₁< . . . <tₑ₂≦tₛ₁<tₑ₁≦Tₑ. (2.2)

Embodiments of the invention use the Lagrangian approach to derive the discretization. Thus, the grid follows the moving sediments. According to embodiments of the invention, the computational grid is constructed in the following manner. First, a grid is constructed in the xy-plane. Then, the grid is extended vertically to form columns. For the purpose of simplicity, it is assumed that the grid is rectangular. However, the xy-grid may be nonuniform, and the mesh sizes in the x- and y-directions can be arbitrary. Thus, a rectangular grid is constructed in xy-plane such that

x₀=0<x₁< . . . <xₙ_{ₓ}₋₁<xₙ_{ₓ}=X, y₀=0<y₁< . . . <yₙ_{_{y}}₋₁<yₙ_{_{y}}=Y,

and nₓ×n_{y} columns are defined by the following

Col_{i,j}(t)={(x,y,z;t):xᵢ₋₁≦x≦xᵢ,yⱼ₋₁≦y≦yⱼ,Zₜₒₚ(t)≦z≦Z_{bot}(t)}.

In accordance with embodiments of the invention, computations can be carried out not only on the whole set of columns, but also on a subset of these columns, or even on a single column.

Each column has the same number of layers n_{z} and some of the layers can have zero thickness in a part of the domain, which indicates that the particular layer has been pinched-off in that portion of the xy plane. One way to start a simulation is to set the computational domain to a zero thickness, i.e. Zₜₒₚ(x,y;Tₛ)=Z_{bot}(x,y;Tₛ). Other ways may have a nonzero thickness, such that one or more layers may already exist.

The total time interval [Tₛ, Tₑ] is preferably split into M smaller intervals Δt=tₙ−tₙ₋₁, Tₛ=t₀< . . . <t_{M}=Tₑ in such a way that for each tₑⱼ (or tₛⱼ) from equation (2.2) there exists index i such that tᵢ=tₑⱼ.

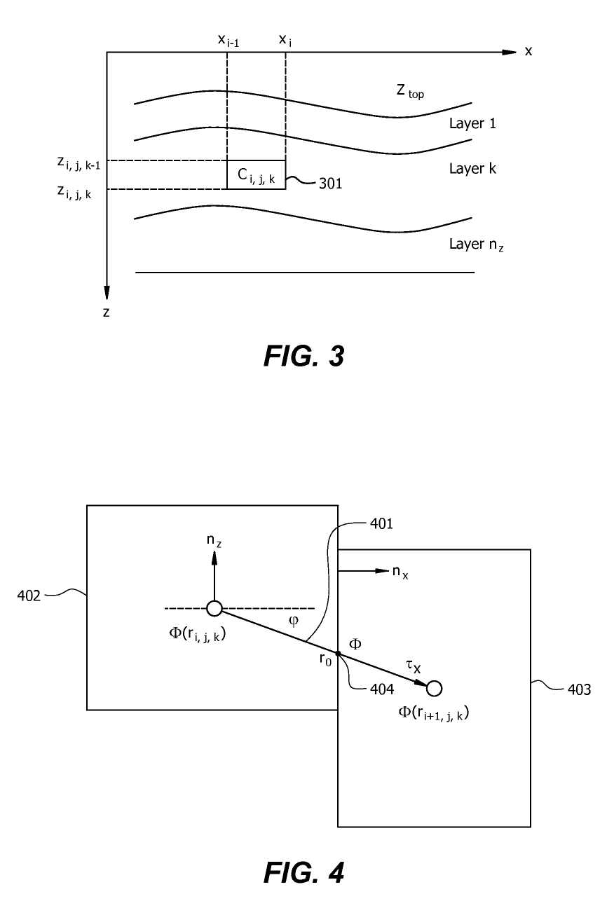

As the computational process moves from one time step to the next one, [tₙ₋₁,tₙ], embodiments of the invention assume that the computational geometry at the beginning of the time step is known, i.e. at time tₙ₋₁. The thicknesses of the cells at time tₙ are unknown a priori and should be a part of the simulation. Since, using embodiments of the invention, the rock movement occurs in vertical direction, the cells are preferably considered to be parallelepipeds whose thickness can vary in time. FIG. 3 depicts an example of a computational cell 301. Cell 301 is located in the column defined by xᵢ₋₁ and xᵢ. As shown in FIG. 3, each layer may have more than one cell in a column, as layer k may have a cell located above cell 301 and a cell located below cell 301. Computational cells may be denoted as

C_{i,j,k}(t)={(x,y,z;t):xᵢ₋₁≦x≦xᵢ,yⱼ₋₁≦y≦yⱼ,z_{i,j,k-1}(t)≦z≦z_{i,j,k}(t)},

where k=1, . . . , n_{z}. In the following discussion, cells may be referred to by one index rather than a triple index for the sake of simplicity. In other words, cell 301 may be referred to using index k as cell Cₖ instead of using the triple index i,j,k resulting in the label C_{i,j,k}.

At the start of the simulation, according to embodiments of the invention, each cell originates at the top of the domain. As sediment is deposited, the cell grows in time. Then, when fully deposited, the cell is then buried and compacted as new cells are deposited at the top of the cell. In absence of diagenesis, any cell after being fully deposited maintains constant rock mass unless, through erosion of the upper cells, the cell moves to the surface, where the cell begins to be eroded.

Different types of transformation can be applied to any computational cell. One type is deposition, whereby the cell is deposited at the top surface of the domain. The cell grows in time, the rock mass increases, and the porosity may change. Another type is downlift, whereby the cell is buried and is compacted due to deposition of new cells on the top of the cell. The rock mass of the cell does not change, and the porosity of the cell usually decreases. Another type is uplift, whereby the cell is moved up in the column due to uplift of the sea bottom or erosion of the upper cells. The rock mass of the cell does not change, and the porosity of the cell may slightly increase. Another type is erosion, whereby the cell undergoes erosion. As the cell is partially or fully eroded, the rock mass of the cell decreases, and the porosity can slightly increase.

As the porosity of any cell C_{i,j,k}(tₙ) can change in time, the thickness of the cell can also change in time, as expressed by

Δz_{i,j,k}ⁿ=z_{i,j,k}ⁿ−z_{i,j,k-1}ⁿ,

thus, the computational grid at time t₀ is not known explicitly and should be a part of the simulation.

The first equation of Set 2.1 is written in terms of excess pressure (I) with respect to hydrostatic load. Excess pressure is used as a primary variable and is considered to be constant in entire computational cell, thus its value is associated with the cell center. The total pore pressure then will be expressed as the sum the hydrostatic pressure and the excess pressure, as expressed by p_{i,j,k}=p_{h;i,j,k}+Φ_{i,j,k}.

Embodiments of the invention discretize the porosity using a finite volume approach, where the discrete value of porosity is an average porosity over the cell, as expressed by

$${φ}_{i , j , k} = \frac{1}{{V}_{i , j , k}} {\int }_{{C}_{i , j , k} ( t )} φ ( x , y , z ) d Ω = \frac{1}{Δ {z}_{i , j , k}} {\int }_{{z}_{i , j , k - 1}}^{{z}_{i , j , k}} φ ( x , y , z ) d z ,$$

where V_{i,j,k} is the volume of the cell.

Let s_{i,j,k} denote the cell solid thickness, which is the total condensed rock volume of the cell divided by the horizontal face area of the cell, as expressed by

$${s}_{i , j , k} = \frac{1}{Δ {x}_{i} Δ {y}_{j}} {\int }_{{C}_{i , j , k} ( t )} ( 1 - φ ( x , y , z ) ) d Ω ,$$

where Δxᵢ and Δyⱼ are sizes of the cell in x and y directions, respectively. In the absence of diagenesis, from the second equation of Set (2.1) it follows that the value of solid thickness can be expressed by

$${s}_{i , j , k} = {\int }_{{z}_{i , j , k - 1}}^{{z}_{i , j , k}} ( 1 - φ ( z ) ) d z = ( 1 - {φ}_{i , j , k} ) Δ {z}_{i , j , k} , \qquad ( 2.3 )$$

and does not change in time after cell C_{i,j,k} is fully deposited. If the start tₛₖ and the end tₑₖ times of the deposition history of the cell are known, as well as the rate of deposition q_{s;i,j,k}, then at any time after tₛₖ the solid thickness of the cell can be determined by

$${s}_{i , j , k} ( t ) = ( {t}_{ek} - {t}_{sk} ) \frac{{q}_{s ; i , j , k}}{{ρ}_{s ; i , j , k}} min \{ 1 , \frac{t - {t}_{sk}}{{t}_{ek} - {t}_{sk}} \} .$$

Vise versa, if the solid thickness of the cell s_{i,j,k} in layer k and the start and stop times of its deposition, tₛₖ and tₑₖ, are known, then the rate of deposition of the layer is computed by

$${q}_{s ; i , j , k} = \frac{{s}_{i , j , k} {ρ}_{s ; i , j , k}}{{t}_{ek} - {t}_{sk}} .$$

Expression (2.3) provides a way to compute average porosity given solid and porous thickness of the cell

$${φ}_{i , j , k} = 1 - \frac{{s}_{i , j , k}}{Δ {z}_{i , j , k}} . \qquad ( 2.4 )$$

With the introduction of solid thickness, the lithostatic load buildup over a single cell can be expressed in the following form

$$Δ {L}_{i , j , k} = {\int }_{{z}_{i , j , k - 1}}^{{z}_{i , j , k}} g ( {ρ}_{s} - {ρ}_{a} ) ( 1 - φ ) d z = g ( {ρ}_{s ; i , j , k} - {ρ}_{a ; i , j , k} ) {s}_{i , j , k} . \qquad ( 2.5 )$$

In case of incompressible fluid, the fluid density does not change throughout the simulation, and thus can be expressed as

ρa;i,j,k=ρₐ⁰. (2.6)

In case of compressible fluid, the dependency of the fluid density on pore pressure should be taken into account, which is represented as the sum of the hydrostatic head pₕ and the excess pressure Φ. Since, for computational purposes, the pore pressure is considered constant in each cell, then the water density is also considered to be constant over the cell, and defined by the value of the pressure on the cell. In this case, the fluid density may be expressed as

ρ_{a;i,j,k}=ρₐ⁰·e^{β(p}^{_{h;i,j,k}}^{+Φ}^{_{i,j,k}}^{-p}^{ₐₜₘ}⁾ (2.7)

Note that the hydrostatic pressure buildup over single cell will have the following form

$$Δ {p}_{h ; i , j , k} = {\int }_{{z}_{i , j , k - 1}}^{{z}_{i , j , k}} g {ρ}_{a} d z = g {ρ}_{a ; i , j , k} Δ {z}_{i , j , k} ,$$

and the value of the hydrostatic pressure p_{h;i,j,k} at the center of cell C_{i,j,k} can be computed as follows

$$\begin{matrix}{p}_{h ; i , j , 1} = {p}_{h ; i , j , surf} + \frac{1}{2} Δ {p}_{h ; i , j , 1} , \\ {p}_{h ; i , j , k} = {p}_{h ; i , j , k - 1} + \frac{1}{2} ( Δ {p}_{h ; i , j , k - 1} + Δ {p}_{h ; i , j , k} ) , k = 2 , … , {n}_{z} ,\end{matrix} \qquad ( 2.8 )$$

where p_{h;i,j,surf} is the value of the hydrostatic pressure at the top surface of column C_{i,j,k}.

As mentioned above, the grid is not known explicitly at simulation time and should be a part of the computation. The cell thickness depends on the amount of sediment buried atop of the cell and the value of excess pressure. The third equation from Set (2.1) is used to obtain the set of discrete equations for cell thicknesses. Dividing both parts by the right hand side and integrating from z_{i,j,k-1}ⁿ to z_{i,j,k}ⁿ provides

$$Δ {z}_{i , j , k} ( t ) = {\int }_{L ( {z}_{i , j , k - 1}^{n} )}^{L ( {z}_{i , j , k}^{n} )} \frac{d L}{g ( {ρ}_{s} - {ρ}_{a} ) ( 1 - φ ( L - Φ , {\hat{σ}}_{E} ) )} . \qquad ( 2.9 )$$

Usually, the integral in the right hand side may not be computed analytically, and instead may be approximated. One-point and two-point approximations may not provide good accuracy due to exponential form of the porosity-effective stress relation. A three-point Simpson formula may provide a good approximation of that integral for computational cells that are not very thick (e.g. ≦1 km) computational cells. In special cases, for example thick cells or highly varying porosity relations, multipoint quadratures may have to be employed to approximate the integral in equation (2.9). The following discussion uses the Simpson rule by way of example only, as other approximations could be used. Thus, using equation (2.5), the approximation of equation (2.9) becomes the following expression (note that indices i and j are omitted for simplicity)

$$Δ {z}_{k} = \frac{{s}_{k}}{6} \cdot ( \begin{matrix}\frac{1}{1 - φ ( {L}_{k}^{top} - {Φ}_{k}^{top} , {\hat{σ}}_{E ; k}^{top} )} + \\ \frac{1}{1 - φ ( {L}_{k} - Φ , {\hat{σ}}_{E ; k} )} + \\ \frac{1}{1 - φ ( {L}_{k}^{bot} - {Φ}_{k}^{bot} , {\hat{σ}}_{E ; k}^{bot} )}\end{matrix} ) \qquad ( 2.10 )$$

where

$$\begin{matrix}{L}_{i , j , k}^{top} ≡ {L}_{i , j , k - 1 / 2} = {L}_{i , j , k} - \frac{1}{2} Δ {L}_{i , j , k} , \\ {L}_{i , j , k}^{bot} ≡ {L}_{i , j , k + 1 / 2} = {L}_{i , j , k} - \frac{1}{2} Δ {L}_{i , j , k} ,\end{matrix} \qquad ( 2.11 )$$

and L_{i,j,k} is the value of the lithostatic load at the center of cell C_{i,j,k} computed as follows

$$\begin{matrix}{L}_{i , j , 1} = \frac{1}{2} Δ {L}_{i , j , 1} , \\ {L}_{i , j , k} = {L}_{i , j , k - 1} + \frac{1}{2} ( Δ {L}_{i , j , k - 1} + Δ {L}_{i , j , k} ) , k = 2 , … , {n}_{z} .\end{matrix} \qquad ( 2.12 )$$

The values of the excess pressure at the cell boundaries Φ_{i,j,k}^{top} and Φ_{i,j,k}^{bot} are provided in the following paragraphs.

The first equation of Set (2.1) is preferably discretized using a finite volume method, which may be applied in the following manner. The first equation is integrated over a computational block, for example C^{t}, and over a time step [tₙ₋₁,tₙ]. Note that each computational block is connected with material coordinates, and hence is moving in time with some velocity yᵣ. Applying the divergence theorem and integrating equation (1.17) over the time step provides

$${\int }_{{t}_{n - 1}}^{{t}_{n}} \frac{D}{Dt} {M}_{a} ( {C}^{t} ) d t - {\int }_{{t}_{n - 1}}^{{t}_{n}} {\int }_{\partial {C}^{t}} ( n , {ρ}_{a} \frac{K}{{μ}_{a}} ∇ Φ ) d s d t = {\int }_{{t}_{n - 1}}^{{t}_{n}} {\int }_{{C}^{t}} {q}_{a} d Ω d t .$$

Note that the first term in the left hand side can be integrated in time explicitly to form

$$( {M}_{a} ( {C}^{{t}_{n}} ) - {M}_{a} ( {C}^{{t}_{n - 1}} ) ) - {\int }_{{t}_{n - 1}}^{{t}_{n}} {\int }_{\partial {C}^{t}} ( n , {ρ}_{a} \frac{K}{{μ}_{a}} ∇ Φ ) d s d t = {\int }_{{t}_{n - 1}}^{{t}_{n}} {\int }_{{C}^{t}} {q}_{a} d Ω d t . \qquad ( 2.13 )$$

Since fluid mass in cell C_{i,j,k} is given by

$${M}_{a} ( {C}_{i , j , k} ) = {\int }_{{C}_{i , j , k}} {ρ}_{a} φ ( x , y , z ) d x d y d z ,$$

which is approximated at time tₙ₋₁ as

Mₐ(C_{i,j,k}^{t}^{_{n−1}})≈ΔxᵢΔyⱼΔz_{i,j,k}ⁿ⁻¹ρ_{a;i,j,k}ⁿ⁻¹φ_{i,j,k}ⁿ⁻¹, (2.14)

while at time t₀ it is approximated using equation (2.4)

Mₐ(C_{i,j,k}^{t}^{ₙ})≈ΔxᵢΔyⱼρ_{a;i,j,k}ⁿ(Δz_{i,j,k}ⁿ−s_{i,j,k}ⁿ). (2.15)

If there are no internal sources of fluid to the cell, then the function qₐ is zero and the only fluid addition or removal is through the deposition or erosion processes. Using equation (1.19), the right hand side in equation (2.13) becomes

$${\int }_{{t}_{n - 1}}^{{t}_{n}} {\int }_{{C}^{t}} {q}_{a} d Ω d t = Δ x Δ y {ρ}_{a ; i , j , k}^{*} {φ}_{i , j , k}^{*} \frac{{q}_{s ; i , j , k} ( {t}_{n - 1} )}{{ρ}_{s ; i , j , k} ( 1 - {φ}_{i , j , k}^{*} )} , \qquad ( 2.16 )$$

where the sign * means that the value is taken either at the surface (input data) or from the previous time step tₙ₋₁ for deposition or erosion, respectively.

Note that each computational block C_{i,j,k}^{t} is in the form of a parallelepiped with faces parallel to the coordinate planes. Thus, the surface integral term in the left hand side of (2.13) can be approximated by the following expression

$${\int }_{{t}_{n - 1}}^{{t}_{n}} {\int }_{\partial {C}_{i , j , k}^{t}} ( n , {ρ}_{a} \frac{K}{{μ}_{a}} ∇ Φ ) d s d t \approx Δ {t}_{n} {\sum }_{m = 1}^{6} {( {\int }_{\partial {C}_{i , j , k ; m}^{{t}^{*}}} ( {n}_{m} , {ρ}_{a} \frac{K}{{μ}_{a}} ∇ Φ ) )}^{*} , \qquad ( 2.17 )$$

Where quantity (−)* represents some approximation of the integral in time and ∂Cₘ denotes m-th face of the parallelepiped. To yield a fully implicit formulation, all parameters should be considered at time t*=tₙ and equation (2.17) becomes

$${\int }_{{t}_{n - 1}}^{{t}_{n}} {\int }_{\partial {C}_{i , j , k}^{t}} ( n , {ρ}_{a} \frac{K}{{μ}_{a}} ∇ Φ ) d s d t \approx Δ {t}_{n} {\sum }_{m = 1}^{6} {( {\int }_{\partial {C}_{i , j , k ; m}^{{t}_{n}}} ( {n}_{m} , {ρ}_{a} \frac{K}{{μ}_{a}} ∇ Φ ) )}^{( n )} . \qquad ( 2.18 )$$

An approximation to the face integral

$${( {\int }_{{s}_{m}} ( {n}_{m} , . ) )}^{( n )}$$

from equation 2.18 is defined below.

Consider the face integral of the normal component of the flux

$${ρ}_{a} \frac{K}{{μ}_{a}} ∇ Φ$$

which is expressed as

$${( Flux {\vert}_{\partial {C}_{m}^{*}} )}^{(* )} = {( {\int }_{\partial {C}_{m}^{*}} ( {n}_{m} , {ρ}_{a} \frac{K}{{μ}_{a}} ∇ Φ ) )}^{*} . \qquad ( 2.19 )$$

An example of the approximation of equation (2.19) is shown in FIG. 4, which depicts the flux 401 from cell C_{i,j,k} 402 to cell C_{i+1,j,k} 403. Note that the flux 401 is in the x-direction and emanates from the center of cell 402 and moves to the center of cell 403. The areas of the x-faces of cells 402 and 403 are respectively noted as S_{x,i} and S_{x,i+1}. Note that the cube Cᵢ has six sides, with one of the sides, S_{x,i}, being adjacent to the cube Cᵢ₊₁, see paragraph [0112].

The difference between Φ(r_{i+1,j,k}) and Φ(r_{i,j,k}) can be expressed through the integral

$$Φ ( {r}_{i + 1 , j , k} ) - Φ ( {r}_{i , j , k} ) = {\int }_{{r}_{i , j , k}}^{{r}_{i + 1 , j , k}} ( ∇ Φ , {{τ}^{->}}_{x} ) d l .$$

The mobility may be expressed as

$$α = \frac{{ρ}_{a}}{{μ}_{a}}$$

and denote w=aK∇Φ. Then

$$∇ Φ = \frac{1}{a} {K}^{- 1} w$$

and the integral can be rewritten as

$$\begin{matrix}{\int }_{{r}_{i , j , k}}^{{r}_{i + j , k}} ( ∇ Φ , {{τ}^{->}}_{x} ) d l = {\int }_{{r}_{i , j , k}}^{{r}_{i + 1 , j , k}} \frac{1}{a} ( {K}^{- 1} w , {{τ}^{->}}_{x} ) d l \\ = {\int }_{{r}_{i , j , k}}^{{r}_{i + 1 , j , k}} \frac{1}{a} ( w , {K}^{- 1} {{τ}^{->}}_{x} ) d l .\end{matrix}$$

Since the permeability tensor K is diagonal in the coordinate system aligned with the layer structure, then the vector \vec{τ}ₓ is an eigenvector of K, i.e. K\vec{τ}ₓ=kₓ\vec{τ}ₓ, thus the above difference can be expressed as

$$Φ ( {r}_{i + 1 , j , k} ) - Φ ( {r}_{i , j , k} ) = {\int }_{{r}_{i , j , k}}^{{r}_{i + 1 , j , k}} \frac{1}{{ak}_{x}} ( w , {{τ}^{->}}_{x} ) d l .$$

In the same manner, fluxes in each cell can be considered as if a potential on the common face of the cells at point r₀ 404 is introduced, where

$${Φ}^{( i , j , k )} ( {r}_{0} ) - Φ ( {r}_{i , j , k} ) = {\int }_{{r}_{i , j , k}}^{{r}_{0}} \frac{1}{{ak}_{x}} ( w , {{τ}^{->}}_{x} ) d l , \\ Φ ( {r}_{i + 1 , j , k} ) - {Φ}^{( i + 1 , j , k )} ( {r}_{0} ) = {\int }_{{r}_{0}}^{{r}_{i + 1 , j , k}} \frac{1}{{ak}_{x}} ( w , {{τ}^{->}}_{x} ) d l .$$

These integrals can be then be approximated by the following expressions

$${Φ}^{( i , j , k )} ( {r}_{0} ) - Φ ( {r}_{i , j , k} ) \approx \frac{1}{a ( {r}_{i , j , k} ) {k}_{x} ( {r}_{i , j , k} )} {( w , {{τ}^{->}}_{x} )}_{i , j , k} \frac{Δ {x}_{i}}{2 cos ϕ} \\ Φ ( {r}_{i + 1 , j , k} ) - {Φ}^{( i + 1 , j , k )} ( {r}_{0} ) \approx \frac{1}{a ( {r}_{i + 1 , j , k} ) {k}_{x} ( {r}_{i + 1 , j , k} )} {( w , {{τ}^{->}}_{x} )}_{i + 1 , j , k} \frac{Δ {x}_{i + 1}}{2 cos ϕ} \qquad ( 2.20 )$$

where (w, \vec{τ}ₓ)_{i,j,k} is the value of the flux component along vector \vec{τ}ₓ at the center of the cell r_{i,j,k}. Since the coefficients a and kₓ are associated with their values at the centers of the computational blocks, they will be referred to below as a_{α,j,k}=a(r_{α,j,k}) and k_{x,α,j,k}=kₓ(r_{α,j,k}), α=i,i+1.

Since the values of the potentials Φ^{(i,j,k)}(r₀) and Φ^{(i+1,j,k)}(r₀) at the same face of adjacent cells coincide and the value of outgoing flux from cell C_{i,j,k} through the face S_{x,i} is equal to the value of incoming flux to cell C_{i+1,j,k} through the face S_{x,i+1}, i.e.

Φ^{(i,j,k)}(r₀)=Φ^{(i+1,j,k)}(r₀)≡Φ₀

and

(w,\vec{τ}ₓ)_{i,j,k}S_{x,i} cos φ=(w,\vec{τ}ₓ)_{i+1,j,k}S_{x,i+1} cos φ,

it is possible to find the value of auxiliary potential Φ₀

$${Φ}_{0} = \frac{\begin{matrix}Φ ( {r}_{i , j , k} ) \frac{{a}_{i , j , k} {k}_{x , i , j , k} {S}_{x , i}}{Δ {x}_{i}} + \\ Φ ( {r}_{i + 1 , j , k} ) \frac{{a}_{i + 1 , j , k} {k}_{x , i + 1 , j , k} {S}_{x , i + 1}}{Δ {x}_{i + 1}}\end{matrix}}{\frac{{a}_{i , j , k} {k}_{x , i , j , k} {S}_{x , i}}{Δ {x}_{i}} + \frac{{a}_{i + 1 , j , k} {k}_{x , i + 1 , j , k} {S}_{x , i + 1}}{Δ {x}_{i + 1}}} . \qquad ( 2.21 )$$

Since the flux from cell C_{i,j,k} to cell C_{i+,i,j,k} is computed by

$${Flux}_{i , j , k}^{i + 1 , j , k} = {\int }_{{S}_{i}} ( {n}_{x} , w ) d s \approx ( {Φ}_{0} - Φ ( {r}_{i , j , k} ) ) \frac{{a}_{i , j , k} {k}_{x , i , j , k} {S}_{x , i}}{Δ {x}_{i} / 2} ,$$

after elimination the value of Φ₀ from the above expression it becomes

$${Flux}_{i , j , k}^{i + 1 , j , k} = \frac{2 ( Φ ( {r}_{i + 1 , j , k} ) - Φ ( {r}_{i , j , k} ) )}{\frac{Δ {x}_{i}}{{a}_{i , j , k} {k}_{x , i , j , k} {S}_{x , i}} + \frac{Δ {x}_{i + 1}}{{a}_{i + 1 , j , k} {k}_{x , i + 1 , j , k} {S}_{x , i + 1}}} . \qquad ( 2.22 )$$

Since S_{x,i}=ΔyⱼΔz_{i,j,k} is the area of the face of the current computational cell, it is possible to replace the expression Δxᵢ/S_{x,i} by (Δxᵢ)²/V_{i,j,k}, where V_{i,j,k}=ΔxᵢΔyⱼΔz_{i,j,k} is the volume of the cell.

Using standard upwinding technique for the mobility term

$${a}_{i + 1 , j , k}^{upw} = \{ \begin{matrix}{a}_{i , j , k} & if Φ ( {r}_{i , j , k} ) \geq Φ ( {r}_{i + 1 , j , k} ) \\ {a}_{i + 1 , j , k} & if Φ ( {r}_{i , j , k} ) < Φ ( {r}_{i + 1 , j , k} )\end{matrix}$$

it is possible to rewrite (2.22) in the following form

$${Flux}_{i , j , k}^{i + 1 , j , k} = \frac{2 {a}_{i + 1 , j , k}^{upw} ( Φ ( {r}_{i + 1 , j , k} ) - Φ ( {r}_{i , j , k} ) )}{\frac{{( Δ {x}_{i} )}^{2}}{{k}_{x , i , j , k} {V}_{i , j , k}} + \frac{{( Δ {x}_{i + 1} )}^{2}}{{k}_{x , i + 1 , j , k} {V}_{i + 1 , j , k}}} . \qquad ( 2.23 )$$

The fluxes through all the other faces of the computational cell C_{i,j,k} are obtained in a similar manner.

The transmissibility coefficients for the faces of C_{i,j,k} are expressed by Tr_{i,j,k}^{α,β,γ} where the set of (α,β,γ) includes {(i±1,j,k),(i,j±1,k),(i,j,k±1)}, as

$$\begin{matrix}{Tr}_{i , j , k}^{i - 1 , j , k} = \frac{2 {a}_{i - 1 , j , k}^{upw}}{\frac{{( Δ {x}_{i} )}^{2}}{{k}_{x , i , j , k} {V}_{i , j , k}} + \frac{{( Δ {x}_{i - 1} )}^{2}}{{k}_{x , i - 1 , j , k} {V}_{i - 1 , j , k}}} , & \\ {Tr}_{i , j , k}^{i + 1 , j , k} = \frac{2 {a}_{i + 1 , j , k}^{upw}}{\frac{{( Δ {x}_{i} )}^{2}}{{k}_{x , i , j , k} {V}_{i , j , k}} + \frac{{( Δ {x}_{i + 1} )}^{2}}{{k}_{x , i + 1 , j , k} {V}_{i + 1 , j , k}}} , & \\ {Tr}_{i , j , k}^{i , j - 1 , k} = \frac{2 {a}_{i , j - 1 , k}^{upw}}{\frac{{( Δ {y}_{j} )}^{2}}{{k}_{y , i , j , k} {V}_{i , j , k}} + \frac{{( Δ {y}_{j - 1} )}^{2}}{{k}_{y , i , j - 1 , k} {V}_{i , j - 1 , k}}} , & \\ {Tr}_{i , j , k}^{i , j + 1 , k} = \frac{2 {a}_{i , j + 1 , k}^{upw}}{\frac{{( Δ {y}_{j} )}^{2}}{{k}_{y , i , j , k} {V}_{i , j , k}} + \frac{{( Δ {y}_{j + 1} )}^{2}}{{k}_{y , i , j + 1 , k} {V}_{i , j + 1 , k}}} , & \\ {Tr}_{i , j , k}^{i , j , k - 1} = \frac{2 {a}_{i , j , k - 1}^{upw}}{\frac{{( Δ {z}_{i , j , k} )}^{2}}{{k}_{z , i , j , k} {V}_{i , j , k}} + \frac{{( Δ {z}_{i , j , k - 1} )}^{2}}{{k}_{z , i , j , k - 1} {V}_{i , j , k - 1}}} , & \\ {Tr}_{i , j , k}^{i , j , k + 1} = \frac{2 {a}_{i , j , k + 1}^{upw}}{\frac{{( Δ {z}_{i , j , k} )}^{2}}{{k}_{z , i , j , k} {V}_{i , j , k}} + \frac{{( Δ {z}_{i , j , k + 1} )}^{2}}{{k}_{z , i , j , k + 1} {V}_{i , j , k + 1}}} . & \end{matrix}$$

Then, in the fully implicit approach the fluxes of equation (2.23) can be approximated at the current time level as

(Flux_{i,j,k}^{α,β,γ})⁽ⁿ⁾=(Tr_{i,j,k}^{α,β,γ})⁽ⁿ⁾(Φ_{α,β,γ}⁽ⁿ⁾−Φ_{i,j,k}⁽ⁿ⁾). (2.24)

Note that there are different types of the boundary conditions that can be enforced on portions of the faces of a given layer, for example a closed boundary, a prescribed influx or efflux (Neumann type), and a prescribed pressure (Dirichlet type). The following paragraphs will describe these boundary conditions. In the description, let one face of the computational block C_{i,j,k} belong to the boundary of the domain. To make the notation more uniform, that face is denoted as (∂C)_{i,j,k}^{α,β,γ} and the potential increment on this face will be denoted as ΔΦ_{i,j,k}^{α,β,γ}. Note that for the internal face

ΔΦ_{i,j,k}^{α,β,γ}=Φ_{α,β,γ}−Φ_{i,j,k}.

For a closed boundary there is no flux, hence

(Flux_{i,j,k}^{α,β,γ})^{(*)}=0,

where (*) denotes the time level when this condition is enforced.

For a prescribed influx or efflux condition, the influx boundary condition embodiments of the invention assume that the fluid flows into the domain. Hence, the expression

$$\begin{matrix}{Q}_{i , j , k}^{α , β , γ} ≡ {( {Flux}_{i , j , k}^{α , β , γ} )}^{(* )} \\ = {( {\int }_{\partial {C}_{i , j , k}^{α , β , γ} } ( {n}_{s} , aK ∇ Φ ) )}^{(* )}\end{matrix}$$

should be negative since nₛ is an outward normal vector and ∇Φ is directed inward. Thus, for that type of boundary it is set

(Flux_{i,j,k}^{α,β,γ})^{(*)}=Q_{i,j,k}^{α,β,γ},

where Q_{i,j,k}^{α,β,γ}≦0. Otherwise, for outflow boundary condition, positive values for fluid efflux should be prescribed Q_{i,j,k}^{α,β,γ}≧0.

For prescribed pressure boundary conditions, embodiments of the invention assume that the capillary pressure is small at the boundary of the domain and the slope of the layers is negligible. Thus, the boundary face may be viewed as orthogonal to the axis d (where d can be x, y, or z). When the pressure is provided at the boundary face (in the middle point r_{b} of the face), the first equation of equations (2.20) may be modified as follows

$${Φ}^{( i , j , k )} ( {r}_{b} ) - Φ ( {r}_{i , j , k} ) = \frac{1}{a ( {r}_{i , j , k} ) {k}_{d} ( {r}_{i , j , k} )} {( w , {n}_{d} )}_{i , j , k} \frac{Δ {d}_{i , j , k}}{2} ,$$

where Δd_{i,j,k} is either Δxᵢ, or Δyⱼ, or Δz_{i,j,k}, depending on the face. Thus, the corresponding flux is determined by

$${Flux}_{i , j , k}^{α , β , γ} = ( Φ ( {r}_{b} ) - Φ ( {r}_{i , j , k} ) ) \frac{{a}_{i , j , k} {k}_{d , i , j , k} {V}_{i , j , k}}{{( Δ {d}_{i , j , k} )}^{2} / 2} ,$$

and transmissibility is respectively defined by

$${Tr}_{i , j , k}^{α , β , γ} = \frac{2 {a}_{i , j , k} {k}_{d , i , j , k} {V}_{i , j , k}}{{( Δ {d}_{i , j , k} )}^{2}} .$$

For the boundary faces orthogonal to either x or y axis, the boundary terms are either

$$\begin{matrix}( {Flux}_{i , j , k}^{i \pm 1 , j , k} ) = ( {Tr}_{i , j , k}^{i \pm 1 , j , k} ) ( {Φ}_{b} - {Φ}_{i , j , k} ) , \\ {Tr}_{i , j , k}^{i \pm 1 , j , k} = \frac{2 {a}_{i , j , k} {k}_{x , i , j , k} {V}_{i , j , k}}{{( Δ {x}_{i} )}^{2}} , \\ or & ( 2.25 ) \\ ( {Flux}_{i , j , k}^{i , j \pm 1 , k} ) = ( {Tr}_{i , j , k}^{i , j \pm 1 , k} ) ( {Φ}_{b} - {Φ}_{i , j , k} ) , \\ {Tr}_{i , j , k}^{i , j \pm 1 , k} = \frac{2 {a}_{i , j , k} {k}_{y , i , j , k} {V}_{i , j , k}}{{( Δ {y}_{j} )}^{2}} . & ( 2.26 )\end{matrix}$$

For the boundary face orthogonal to z axis (z_{b}−z_{i,j,k})=±Δz_{i,j,k}/2, where for the upper face (z_{b}<z_{i,j,k}) the sign is “−”, and for the bottom face (z_{b}>z_{i,j,k}) the sign is “+”. Generally, in basin modeling simulations, there is a no flow boundary condition on the bottom of the computational domain and pressure is prescribed on the top of the domain. For the top face the flux is given by

$$( {Flux}_{i , j , k}^{i , j , k - 1} ) = ( {Tr}_{i , j , k}^{i , j , k - 1} ) ( {Φ}_{b} - {Φ}_{i , j , k} ) , \\ {Tr}_{i , j , k}^{i , j , k - 1} = \frac{2 {a}_{i , j , k} {k}_{z , i , j , k} {V}_{i , j , k}}{{( Δ {z}_{k} )}^{2}} . \qquad ( 2.27 )$$

The expressions (2.25), (2.26), and (2.27) can be incorporated in the matrix equation (2.13) by adding terms (Tr_{i,j,k}^{α,β,γ})Φ_{b} into the right-hand side vector and all the rest to the diagonal term of the matrix. The rates are then obtained by substituting the solution Φ_{i,j,k} back into equations (2.25), (2.26), and (2.27).

For computation of the cell thickness in equation (2.10), an approximation of the excess pressure is useful at the top and bottom boundaries of the cell, namely Φ_{i,j,k}^{top} and Φ_{i,j,k}^{bot}. Thus, due to the pressure boundary condition at the top boundary of the topmost cell the following condition should be enforced

Φ_{i,j,l}^{top}=0.

On the bottom of the domain there is no flow boundary condition, for this reason for the bottom boundary of the lowest cell may have the following pressure condition

Φ_{i,j,n}_{_{z}}^{bot}=Φ_{i,j,n}_{_{z}}.

For any other boundaries, there always have to be the top and the bottom neighboring cells, moreover, due to excess pressure continuity,

Φ_{i,j,k}^{bot}=Φ_{i,j,k+1}^{top}, k=1, . . . , n_{z}−1. (2.28)

The value of the excess pressure at the boundary between two adjacent cells is defined using the flux continuity condition derived in above paragraph, namely equation (2.21), the excess pressure for the face orthogonal to z-direction may be expressed as

$${Φ}_{i , j , k}^{bot} = \frac{{Φ}_{i , j , k} {k}_{z , i , j , k} / Δ {z}_{i , j , k} + {Φ}_{i , j , k + 1} {k}_{z , i , j , k + 1} / Δ {z}_{i , j , k + 1}}{{k}_{z , i , j , k} / Δ {z}_{i , j , k} + {k}_{z , i , j , k + 1} / Δ {z}_{i , j , k + 1}} . \qquad ( 2.29 )$$

### System of Nonlinear Equations

From equations (2.15), (2.23), and (2.24), the discretized version of equation (2.13) contains unknown thicknesses of the computational cells Δz and values of excess pressure Φ, as well as functions kₓ, k_{y}, k_{z}, and ρₐ, which in turn depend on average cell porosity φ, hydrostatic pressure pₕ, and excess pressure Φ. The values of thicknesses Δz can be determined from the equation (2.10), which contains unknowns Δz and Φ as well as the values of lithostatic load L, fluid density ρₐ, and again functions kₓ, k_{y}, k_{z}. Taking into account the equation (2.4) between porosity and thickness, permeability coefficients kₓ, k_{y}, k_{z} can be rewritten as functions of Δz. To close the system of equations for determining Δz and Φ, two additional equations are required for L and pₕ, namely equations (2.12) and (2.8). Thus, the set of unknowns describing the fluid flow in compacting media contains four variables, namely excess pressure Φ, cell thicknesses Δz, lithostatic load L, and hydrostatic pressure pₕ.

Introduce a vector of unknowns comprising the four variables as follows

X=(Φ,Δz,L,Pₕ),

with the following subvectors

Φ={Φ_{i,j,k}}, Δz={Δ_{i,j,k}}, L={L_{i,j,k}}, Pₕ={p_{h;i,j,k}},

where Φ_{i,j,k} is the excess pressure, Δz_{i,j,k} is the cell thicknesses, L_{i,j,k} is the lithostatic load, and p_{h;i,j,k} is the hydrostatic pressure, respectively.

Then the discretization of Set (2.1) can be written in the form of the system of nonlinear algebraic equations

F(X⁽ⁿ⁾)=0,

or in component-wise form (for internal cells (i,j,k))

$$\begin{matrix}{F}_{Φ ; i , j , k} ≡ Δ {x}_{i} Δ {y}_{j} {ρ}_{a ; i , j , k}^{n} ( Δ {z}_{i , j , k}^{n} - {s}_{i , j , k}^{n} ) - {\tilde{M}}_{i , j , k}^{n - 1} + Δ t \{ {Tr}_{i , j , k}^{i , j , k - 1} ( {Φ}_{i , j , k}^{n} - {Φ}_{i , j , k - 1}^{n} ) + {Tr}_{i , j , k}^{i , j , k + 1} ( {Φ}_{i , j , k}^{n} - {Φ}_{i , j , k + 1}^{n} ) + {Tr}_{i , j , k}^{i - 1 , j , k} ( {Φ}_{i , j , k}^{n} - {Φ}_{i - 1 , j , k}^{n} ) + {Tr}_{i , j , k}^{i + 1 , j , k} ( {Φ}_{i , j , k}^{n} - {Φ}_{i + 1 , j , k}^{n} ) + {Tr}_{i , j , k}^{i , j - 1 , k} ( {Φ}_{i , j , k}^{n} - {Φ}_{i , j - 1 , k}^{n} ) + {Tr}_{i , j , k}^{i , j + 1 , k} ( {Φ}_{i , j , k}^{n} - {Φ}_{i , j + 1 , k}^{n} ) \} = 0 , & ( 3.1 ) \\ {F}_{Δ z ; i , j , k} ≡ Δ {z}_{i , j , k}^{n} - \frac{{s}_{i , j , k}^{n}}{6} \cdot ( \frac{1}{1 - φ ( {L}_{i , j , k}^{top} - {Φ}_{i , j , k}^{top} , {\hat{σ}}_{E ; i , j , k}^{top} )} + \frac{4}{1 - φ ( {L}_{i , j , k} - {Φ}_{i , j , k} , {\hat{σ}}_{E ; i , j , k} )} + \frac{1}{1 - φ ( {L}_{i , j , k}^{bot} - {Φ}_{i , j , k}^{bot} , {\hat{σ}}_{E ; i , j , k}^{bot} )} ) = 0 , & ( 3.2 ) \\ {F}_{L ; i , j , k} ≡ {L}_{i , j , k}^{n} - {L}_{i , j , k - 1}^{n} - \frac{g}{2} ( ( {ρ}_{s ; i , j , k} - {ρ}_{a ; i , j , k}^{n} ) {s}_{i , j , k}^{n} + ( {ρ}_{s ; i , j , k - 1} - {ρ}_{a ; i , j , k - 1}^{n} ) {s}_{i , j , k - 1}^{n} ) = 0 , & ( 3.3 ) \\ {F}_{{p}_{h} ; i , j , k} ≡ {p}_{h ; i , j , k}^{n} - {p}_{h ; i , j , k - 1}^{n} - \frac{g}{2} ( {ρ}_{a ; i , j , k}^{n} Δ {z}_{i , j , k}^{n} + {ρ}_{a ; i , j , k - 1}^{n} Δ {z}_{i , j , k - 1}^{n} ) = 0. & ( 3.4 )\end{matrix}$$

The term \tilde{M}_{i,j,k}ⁿ⁻¹ in the first set of equations (3.1) is the sum of two expressions (2.14) and (2.16)

$${\tilde{M}}_{i , j , k}^{n - 1} = Δ {x}_{i} Δ {y}_{j} ( Δ {z}_{i , j , k}^{n - 1} {ρ}_{a ; i , j , k}^{n - 1} {φ}_{i , j , k}^{n - 1} + {ρ}_{a ; i , j , k}^{*} {φ}_{i , j , k}^{*} \frac{{q}_{s} ( {t}_{n - 1} )}{{ρ}_{s ; i , j , k} ( 1 - {φ}_{i , j , k}^{*} )} ) ,$$

where the sign * means that the value is taken either at the surface (input data) or from the previous time step tₙ₋₁ for deposition or erosion, respectively. The fluid density is defined either by equation (2.6) or by equation (2.7) for incompressible or compressible fluid flows, respectively. The equations define the over pressure, cell thicknesses, and sedimentary load for a cell. These three equations may be used to define a domain that includes an incompressible fluid. If the fluid is compressible, then the equation for the hydrostatic pressure is needed to describe the domain.

Transmissibilities Tr_{i,j,k}^{α.β,γ} are defined by (2.24) with modifications for boundary cells as described in boundary conditions section.

The values of L_{i,j,k}^{top} and L_{i,j,k}^{bot} in the second set of equations (3.2) are defined by expressions (2.11), while the values of Φ_{i,j,k}^{top} and Φ_{i,j,k}^{bot} are computed using expressions (2.28) and (2.29). The equations (3.3) and (3.4) are augmented at the top boundary in the following manner

$${F}_{L ; i , j , 1} ≡ {L}_{i , j , 1}^{n} - \frac{g}{2} \cdot ( {ρ}_{s ; i , j , 1} - {ρ}_{a ; i , j , 1}^{n} ) {s}_{i , j , 1}^{n} = 0 , \\ {F}_{{p}_{h} ; i , j , 1} ≡ {p}_{h ; i , j , 1}^{n} - {p}_{h ; i , j , surf}^{n} - \frac{g}{2} \cdot {ρ}_{a ; i , j , 1}^{n} Δ {z}_{i , j , 1}^{n} = 0.$$

Embodiments of the invention use a consistent set of equations to describe the compaction of the domain and the fluid flow of the domain simultaneously. Embodiments of the invention balance mass, momentum, and constitutive relations to determine the compacting and/or decompacting domain. Embodiments of the invention describe the fluid flow in the domain. Embodiments of the invention introduce unknowns to describe porosity. Porosity may be dependent on the effective stress, which is a physical behavior, which depends on the pressure and on the load, which comes from the compaction.

Note that other embodiments of the invention may involve other unknown variables. For example, another embodiment of the invention may describe the fluid flow and compaction of the domain using total pressure, hydrostatic pressure, thicknesses, and effective stress. Any set of unknowns may be used so long as the set is consistent over the domain. Additional variables can be added to the set of equations, for example, temperature, along with additional equation or equations describing their distribution in space and time. Usually, the coefficients involved in the system of equations (3.1)-(3.4) do not depend strongly on other variables like temperature, thus for the sake of simplicity of description, these additional variables are not considered.

The various processes and methods outlined above may be combined in one or more different methods, used in one or more different systems, or used in one or more different computer program products according to various embodiments of the invention.

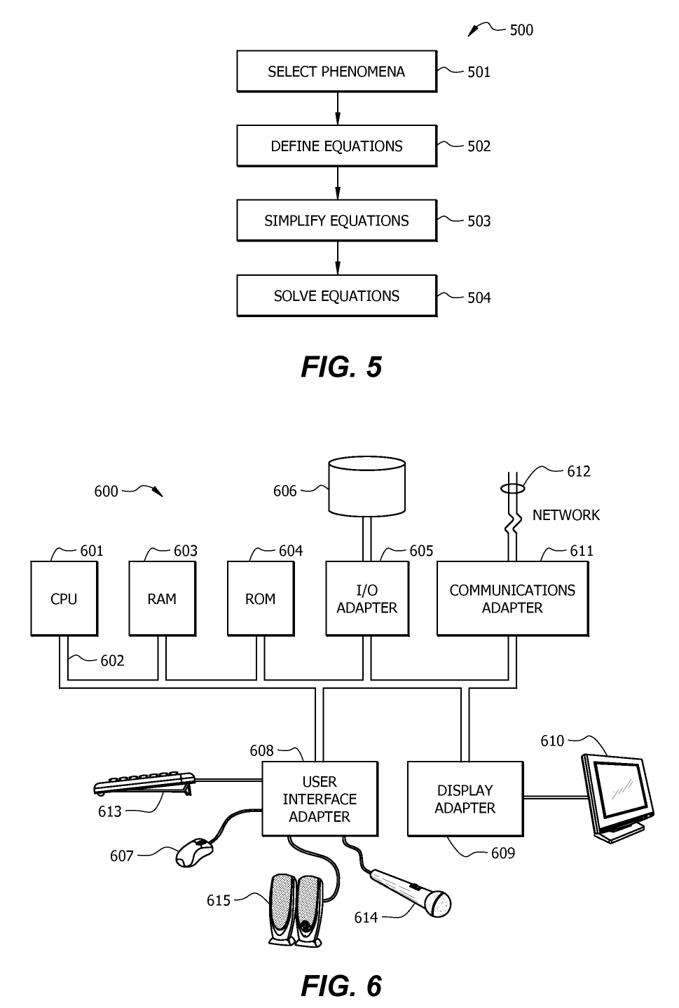

For example, one exemplary method 500 may be to model a physical region on a computer, as shown in FIG. 5. As described above, a physical region can be modeled by using one or more processes or phenomena that are occurring within the region, block 501. For example, in a subsurface geological basin, fluid flow and sediment compaction may be used to model the basin. Thus, by modeling the accumulation and/or erosion of sediment, and how fluids are flow the sediment, an accurate model of the basin may be obtained. Modeling such phenomena can be difficult because fluid flow and compaction are coupled, in that fluid flow depends upon compaction and vice versa.

According to embodiments of the invention, the model uses a set of equations to describe the phenomena, block 502. For example, a set of equations that refer to over-pressure for a region, thickness for the region, and sediment load may be used to describe the coupled phenomena of fluid flow and compaction, if the fluid is incompressible, e.g. water or oil. If the fluid is compressible, e.g. a gas or natural gas, then an addition equation referring to hydrostatic pressure may be used.

The equations can be simplified by imposing one or more assumptions on the model, block 503. While the assumptions may introduce errors or inaccuracies when comparing the model with the actual physical basin, the assumptions allow for the equations to solved in a computationally efficient manner. The assumptions may be imposed on the phenomena or on the equations themselves. For example, one assumption may be that a rate of sediment accumulation is known. The actual rate in the physical basin may not be known, thus a rate may be assumed for the model. Another assumption may be that the compaction only occurs in a vertical direction. In other words, no compaction is occurring in the lateral directions. Another assumption may be that the compaction is relatively irreversible. This means that the sediment will mostly compact only, with some of amount of decompaction occurring during erosion of the sediment or during uplift, but not fully returning to a initial state. Embodiments of the invention may use other assumptions.

After the equations have been simplified, they may be solved to simultaneously describe the two phenomena using the data, block 504. By solving the equations, the model will accurately depict the operation of the phenomena in the region. The model may then be used to assist in with a modification of the physical region. For example, the model may be used to more efficiently extract subsurface oil or gas from the basin.

Note that any of the functions described herein may be implemented in hardware, software, and/or firmware, and/or any combination thereof. When implemented in software, the elements of the present invention are essentially the code segments to perform the necessary tasks. The program or code segments can be stored in a computer readable medium or transmitted by a computer data signal. The “computer readable medium” may include any medium that can store or transfer information. Examples of the computer readable medium include an electronic circuit, a semiconductor memory device, a ROM, a flash memory, an erasable ROM (EROM), a floppy diskette, a compact disk CD-ROM, an optical disk, a hard disk, a fiber optic medium, etc. The computer data signal may include any signal that can propagate over a transmission medium such as electronic network channels, optical fibers, air, electromagnetic, RF links, etc. The code segments may be downloaded via computer networks such as the Internet, Intranet, etc.

FIG. 6 illustrates computer system 600 adapted to use the present invention. Central processing unit (CPU) 601 is coupled to system bus 602. The CPU 601 may be any general purpose CPU, such as an Intel Pentium processor. However, the present invention is not restricted by the architecture of CPU 601 as long as CPU 601 supports the inventive operations as described herein. Bus 602 is coupled to random access memory (RAM) 603, which may be SRAM, DRAM, or SDRAM. ROM 604 is also coupled to bus 602, which may be PROM, EPROM, or EEPROM. RAM 603 and ROM 604 hold user and system data and programs as is well known in the art.

Bus 602 is also coupled to input/output (I/O) controller card 605, communications adapter card 611, user interface card 608, and display card 609. The I/O adapter card 605 connects to storage devices 606, such as one or more of a hard drive, a CD drive, a floppy disk drive, a tape drive, to the computer system. The I/O adapter 605 is may connected to printer, which would allow the system to print paper copies of information such as document, photographs, articles, etc. Note that the printer may be a printer (e.g. inkjet, laser, etc.), a fax machine, or a copier machine. Communications card 611 is adapted to couple the computer system 600 to a network 612, which may be one or more of a telephone network, a local (LAN) and/or a wide-area (WAN) network, an Ethernet network, and/or the Internet network. User interface card 608 couples user input devices, such as keyboard 613 and pointing device 607, to the computer system 600. User interface card 608 may also provide sound output to a user via speaker(s). The display card 609 is driven by CPU 601 to control the display on display device 610.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for modeling a physical region comprising:
receiving data that defines at least one physical characteristic of the physical region;
selecting a first phenomena and a second phenomena, wherein the first and second phenomena are coupled over the physical region for modeling;
defining a set of equations that describe the first and second phenomena, wherein the equations are consistent over the physical region;
simplifying the set of equations by imposing at least one assumption on at least one of the first phenomena, the second phenomena, and the set of equations; and
solving the set of equations to simultaneously describe the two phenomena using the data.

2. The method of claim 1, wherein the physical region is a subsurface geological basin and the two phenomena are flow of a fluid and compaction of a material in the basin in which the fluid is located.

3. The method of claim 2, wherein the fluid is at least one of:
oil, natural gas, water, a liquid, a gas, and fluid with a radioactive isotope.

4. The method of claim 2, wherein the material is sediment.

5. The method of claim 4, wherein the at least one assumption at least one of:
a rate of sediment accumulation is known;
the compaction only occurs in a vertical direction; and
the compaction is relatively irreversible.

6. The method of claim 2, further comprising:
providing a grid on a model of the physical region, wherein the grid comprises a plurality of cells.

7. The method of claim 6, wherein the solving is performed for each cell of the grid.

8. The method of claim 6, wherein during modeling each cell of the grid is grown in a vertical direction to model material accumulation over time.

9. The method of claim 8, wherein during modeling at least one cell becomes buried in the model as other cells are grown above the one cell.

10. The method of claim 8, wherein each cell is a parallelepiped cell.

11. The method of claim 8, wherein an x-direction and a y-direction that define horizontal plane of a cell are aligned with stratigraphic time lines.

12. The method of claim 6, wherein the fluid is a compressible fluid, and the set of equations comprises:
a first equation that defines an over pressure for each cell, a second equation that defines a cell thickness for each cell, a third equation that defines a material load for each cell, and a fourth equation that defines a hydrostatic pressure for each cell.

13. The method of claim 6, wherein the fluid is an incompressible fluid, and the set of equations comprises:
a first equation that defines an over pressure for each cell, a second equation that defines a cell thickness for each cell, and a third equation that defines a material load for each cell.

14. The method of claim 6, further comprising:
applying at least one transformation to a cell;
wherein the transformation is one of deposition, downlift, uplift, and erosion.

15. The method of claim 6, further comprising;
imposing at least one boundary condition on a cell that is adjacent to an edge of the region.

16. The method of claim 1, wherein the physical region is a subsurface geological basin, and the model involves subsurface oil, and the solving assists in the extraction of the oil from the basin.

17. The method of claim 1, further comprising:
deriving the data from information from a sensor that measured the at least one physical characteristic of the physical region.

18. A computer program product having a computer readable medium having computer program logic recorded thereon for modeling a subsurface geological basin on a computer comprising:
code that defines a set of equations that describe fluid flow and sediment compaction, wherein the equations are consistent over the basin, and wherein code is simplified by the imposition of at least one assumption on at least one of the fluid flow, sediment compaction, and the set of equations; and
code for solving the set of equations to simultaneously to describe the fluid flow and sediment compaction in the basin.

19. The computer program product of claim 18, further comprising:
code for providing a grid on a model of the basin, wherein the grid comprises a plurality of cells.

20. The computer program product of claim 19, wherein the set of equations comprises:
code that describes a first equation that defines an over pressure for each cell;
code that describes a second equation that defines a cell thickness for each cell; and
code that describes a third equation that defines a material load for each cell.

21. The computer program product of claim 19, further comprising:
code for applying at least one transformation to a cell;
wherein the transformation is one of deposition, downlift, uplift, and erosion.

22. The computer program product of claim 19, wherein the at least one assumption comprises:
a first assumption that a rate of sediment accumulation is known;
a second assumption that the compaction only occurs in a vertical direction; and
a third assumption that the compaction is relatively irreversible.

23. The computer program product of claim 18, wherein the fluid is oil.

24. A method for modeling a sub-surface geological basin on a computer comprising:
receiving data that defines at least one physical characteristic of the basin;
defining a set of equations that describe a fluid flow and a compaction of sediment in the basin, wherein the equations are consistent over the physical region;
simplifying the set of equations by imposing an assumption that the compaction only occurs in a vertical direction; and
solving the set of equations to simultaneously describe the two phenomena using the data.

25. The method of claim 24, wherein the model involves subsurface oil, the method further comprises:
deriving the data from information from a sensor that measured the at least one physical characteristic of the physical region; and
using the solved equations to assist in the extraction of the oil from the basin.

26. The method of claim 25, wherein the physical region is a subsurface geological basin and the two phenomena are flow of a fluid and compaction of a material in the basin in which the fluid is located.

27. The method of claim 25, further comprising:
producing a basin model of the subsurface geological basin based on the set of solved equations;
predicting the location of hydrocarbons within the physical region based on the basin model; and
arranging production infrastructure to extract hydrocarbons within the physical region based on the predicted location of the hydrocarbons.

28. The method of claim 27, further comprising evaluating production potential of the physical region for hydrocarbons based on the basin model.
